(19) United States
(12) Patent Application Publication
(10) Pub. No.: US 2024/0367468 A1
(43) Pub. Date: Nov. 7, 2024

(54) IMPROVEMENTS IN OR RELATING TO HITCHING

(71) Applicant: PEARSON ENGINEERING LIMITED, Newcastle Upon Tyne (GB)

(72) Inventors: Jason Riby, Newcastle upon Tyne (GB); Jon Taylor, Newcastle upon Tyne (GB)

(21) Appl. No.: 18/291,469

(22) PCT Filed: Jul. 28, 2022
(86) PCT No.: PCT/EP2022/071170

§ 371 Date: Jan. 23, 2024

(30) Foreign Application Priority Data
Jul. 28, 2021 (GB) 2110837.8

(51) Int. Cl. B60D 1/167; A01B 59/00; B60D 1/54; F41H 11/16

(52) U.S. Cl. CPC B60D 1/1675; B60D 1/54; F41H 11/16; A01B 59/004; A01B 59/008

(57) ABSTRACT

A vehicle-to-implement hitch is provided and comprises a force transfer hitch connector adapted to provide a hitch point to which an implement can be connected. The connector is couplable to the vehicle by one or more flexible tensioning members which are, or can be moved so as to be, taut whereby to create a rigid structure comprising a hitch location such that the hitch point is movable.

The present invention relates generally to the attachment of implements to vehicles and particularly, although not exclusively, to a vehicle-to-equipment hitch.

A hitch system binds a prime mover and an implement into a single working unit. A hitch is a link through which the vehicle delivers tractive effort and/or torque in the form of pull or push to counteract a force from an implement or attachment. A hitch point (virtual or real) is the point on the vehicle (as an integral part or otherwise) through which the “line of push” must pass. Real hitch points (RHP), e.g., a conventional car/trailer tow ball, cannot be

positioned low to the ground, particularly on off-road vehicles, where they might come into contact with the ground causing damage such as disengagement of the hitch or reducing vehicle mobility.

Virtual hitch points (VHP) generated by linkage mechanisms e.g., 4-bar agricultural tractor hitches can be designed so the physical parts are high above ground but the VHP occurs in a different but desirable location e.g. very low to the ground. However, the VHP position moves as the linkage articulates possibly to other less desirable locations.

The present invention seeks to provide improvements in or relating to hitching.

Some embodiments provide or relate to a vehicle to equipment hitch point.

An aspect of the present invention provides a vehicle-to-implement hitch comprising a force transfer hitch connector adapted to provide a hitch point to which an implement can be connected, wherein the connector is couplable to the vehicle by one or more flexible tensioning members which are, or can be moved so as to be, taut whereby to create a rigid structure comprising a hitch location such that the hitch point is movable.

An aspect of the present invention provides a vehicle-to-implement hitch comprising a force transfer connector to which an implement can be connected, the connector is supported by one or more tensioning members which are, or can be moved so as to be, taut whereby to create a rigid structure comprising a hitch location.

The hitch may be movable between a stowed configuration to a deployed configuration; it may be deployable from a vehicle in use.

The one or more tensioning members may be relaxed in the stowed configuration and taut in the deployed position.

In some embodiments the hitch location can move under certain circumstances. For example the hitch location may be movable, in use, if overloaded and/or if required to be stowed somewhere different.

Some aspects and embodiments provide or relates to a hitch that is stowed and then deployed.

Some aspects and embodiments provide or relates to a hitch at a desirable location that in some circumstances can move away from that location; one alternative location might be a stowed position.

Some aspects and embodiments provide or relate to the ability to place a hitch at a desirable location from which it might need to move in some circumstances e.g., if overloaded or if required to stow somewhere different.

Some aspects and embodiments of the present invention enable the creation of a hitch point in previously unoccupied space.

An aspect of the present invention provides a vehicle-to-implement hitch, the hitch is movable from a stowed configuration to a deployed configuration and is deployable from a vehicle in use, the hitch comprises a force transfer connector to which an implement can be connected, the connector is supported by one or more tensioning members which are relaxed in the stowed configuration and taut in the deployed position whereby to create a rigid structure comprising a hitch location.

In aspects and embodiments of the present invention the hitch location could, for example, be provided as or generally in the form of a point or an axis.

The hitch location could, for example, be provided as or generally in the form of a ball joint, a Hooke's joint, a universal joint, or a pin joint.

The form of the hitch may remove one or more degrees of freedom from a hitch location e.g., one or two rotational degrees of freedom.

When overloaded the hitch may be configured to permit translation. Rotational degrees of freedom may be unchanged in an overload situation.

The connector may, for example, be a boom. In some embodiments the boom can articulate.

The connector may form part of the hitch location.

The connector may be “forward” (e.g. in advance of) the hitch location.

The hitch may further comprise one or more actuators for moving the hitch from the stowed to the deployed configuration.

In some embodiments the hitch comprises a first actuator for moving the tensioning member/s to the deployed position and a second actuator for moving the connector to a deployed position.

In embodiments with multiple actuators the actuators may, for example, deploy in sequence or simultaneously. For example, in one embodiment the tensioning member/s are fully deployed followed by deployment of the connector.

A hitch point may be, provide or form part of a real or virtual hitch point.

The or each actuator may be pre-charged and stored energized.

The or each actuator may be connected or connectable to an external power source.

The or each actuator may be a gas strut.

The or each tensioning/tensionable member may be a cable, rope, strap, cord, chain or the like.

The or each tensioning/tensionable member may be a wire rope.

The or each tensioning/tensionable member may be a telescoping cylinder.

Excess member length may be controlled to ensure they pack neatly; for example excess length may be controlled by additional weak springs or weak restraints.

Taut ropes may be used to provide lateral stiffness (i.e. into/out of the plane of the figures) to the mechanisms.

Some embodiments may be based on the use of flexible elements such and cables, ropes or chains, which become rigid in tension after the deployment event.

Some embodiments provide a hitch point formed as part of a triangular linkage, with the hitch point formed at/by an apex.

Some embodiments form a hitch point in space using actuators and rope.

In some embodiments a hitch point is formed by two tautable cables and a gas spring.

Some embodiments provide a hitch point that is movable in the event of an overload.

The hitch point may be or form part of a generally triangular linkage, with, for example, the hitch point itself being formed at a tip of the triangle.

The hitch may comprise means for locking the mechanism, or parts of the mechanism, into the stowed position.

The present invention also provides a hitch mechanism comprising a rigid, deployable structure which is deployed from a compact, stowed configuration using actuators and flexible members which becomes rigid when tensioned and create a real hitch point (RHP) at its extremity, whereby the resulting structure is able to collapse if hits an obstacle and then re-form after passing the obstacle.

The present invention also provides a hitch or hitch mechanism as claimed in any preceding claim in combination with a vehicle.

Hitches may be provided and the front and/or rear of a vehicle. For example, the hitch may be configured for use with front end equipment, such as equipment to be used in conjunction with a military vehicle (such as a plough or dozer blade).

The present invention also provides a mine clearance system comprising a vehicle provided with one or more hitches or hitch mechanisms as defined herein, and a surface clearance implement connected to the vehicle via the hitch/es or hitch mechanism/s.

In some embodiments the hitch point may be configured to be very low to the ground, which despite being very low is tolerant to striking the ground if this occurs.

The principles of the present invention allow for creation of structural members in a location that could not be achieved when the equipment is stowed without detriment to the host vehicle. This can provide for optimized hitch point characteristics that could not be achieved with permanently located structures.

The lightweight structure may be loaded beyond the limits of typical equipment. The nature of the flexible elements allows for a controlled overload without damage to the equipment. This provides for optimized load bearing characteristics, strength and weight with reduced risk of damage to the operational parts.

The pseudo-rigid structure provides for a controlled over-load reaction from which the structure can recover without damage.

Some aspects of the present invention provides or relates to a surface clearance device, such as an implement for the clearance of surface laid or scattered mines, in a lightweight and compact system.

Surface clearance devices can be powerful but bulky and heavy pieces of equipment which, when fitted, reduce the capability of the host vehicle. They are often very strong and capable they can be a considerable size, even when not in use.

Some embodiments provide or relate to a rigid, deployable structure which is deployed from a compact, stowed configuration using actuators (such as gas struts) and flexible members (such as wire rope) which becomes rigid when tensioned and create a real hitch point (RHP) at its extremity. The resulting structure is able to collapse if it does hit an obstacle such as the ground and then re-form after passing the obstacle, temporarily moving the RHP only if required in this situation.

This invention allows, for example, a mine clearance device to be fitted to nearly any vehicle with minimal impact. It could, for example, be worn as a “life-jacket” to protect against attack of scatterable mines, without the need for heavy engineering vehicles to accompany. The solution could be applied to front-line combat vehicles and to logistics vehicles, equally.

In some embodiments the mechanism can collapse upwards if it strikes the ground and rearwards if draft force is too high. Alternatively or additionally the mechanism may also protect if reversing and draft force were too high in that direction, then it may deflect forwards.

Some embodiments provide or relate to a 2-dimensional 2 rope principle in which the hitch point can move anywhere it needs to if it is overloaded in a space defined by 2 radii—the taut lengths of the 2 cables (assuming it is also constrained to stay in a 2D plane).

Some embodiments have multiple sets of this 2-dimensional mechanism. In other embodiments a 3-dimensional mechanism with 3 ropes and one actuator tensioning them may, for example, be provided. In that case the hitch point can move, if overloaded, anywhere in a 3D envelope created from 3 radii of 3 rope lengths.

The pseudo-rigid structure of some embodiments provides for a controlled over-load reaction from which the structure can recover without damage. In some embodiments this works for 3D as well as 2D and overloads in any direction within a geometric envelop defined by the taut members.

Some embodiments provide or relate to a 2D envelope in which a hitch point can move. The same logic may apply in 3D, but the envelope is more complex.

Different aspects and embodiments of the invention may be used separately or together.

Further particular and preferred aspects of the present invention are set out in the accompanying independent and dependent claims. Features of the dependent claims may be combined with the features of the independent claims as appropriate, and in combinations other than those explicitly set out in the claims.

The present invention is more particularly shown and described, by way of example, in the accompanying drawings, in which:

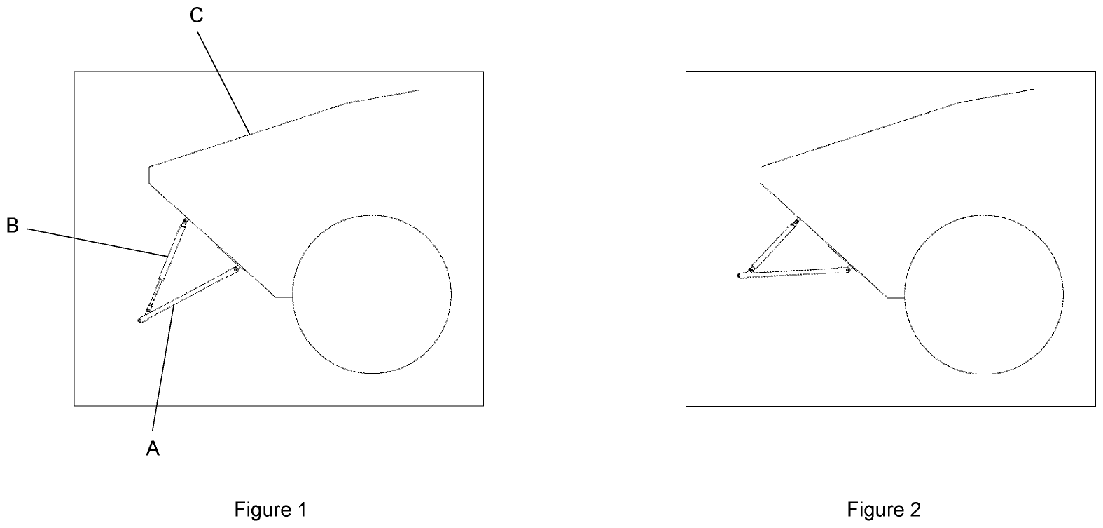

FIGS. 1 to 7—hitch point information and discussion.

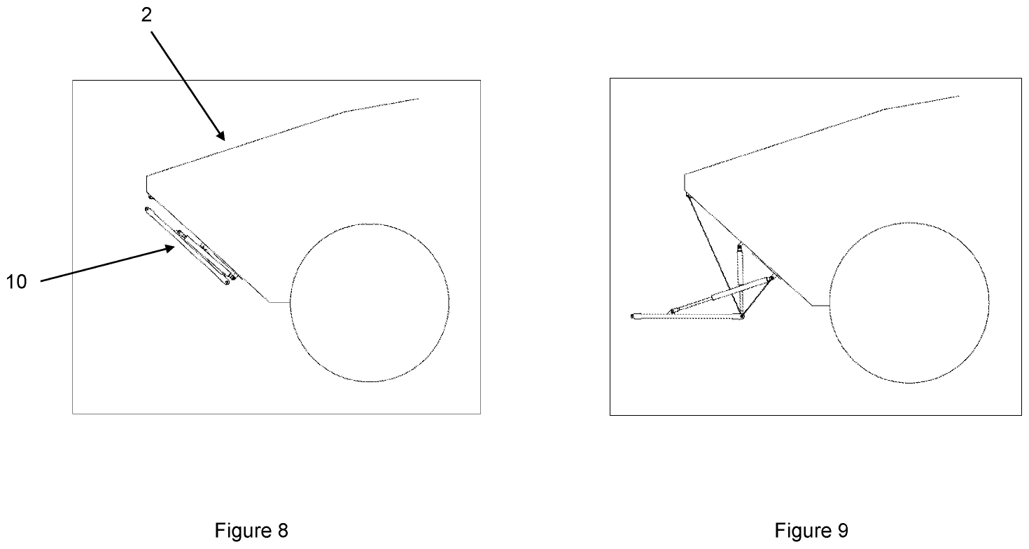

FIG. 8—the hitch point deployment structure in a stowed position.

FIG. 9—the deployment structure in a deployed position.

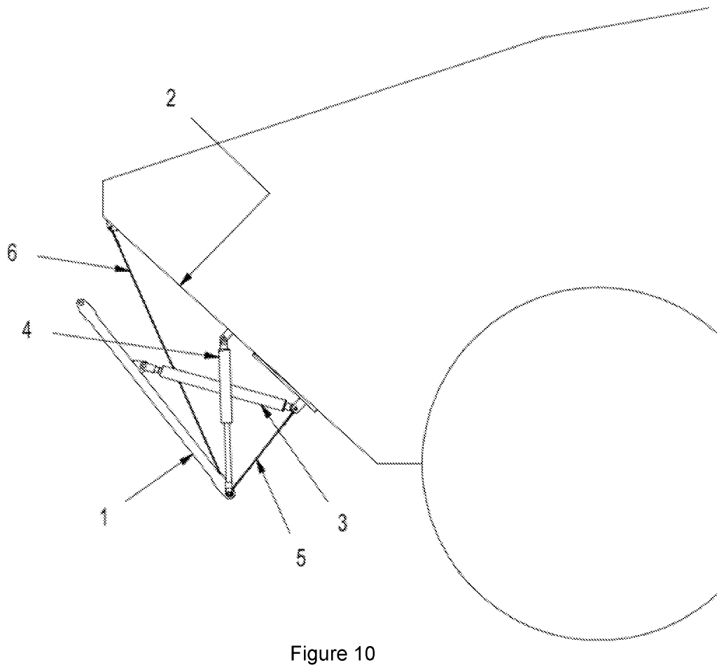

FIG. 10—the hitch point in an intermediate position.

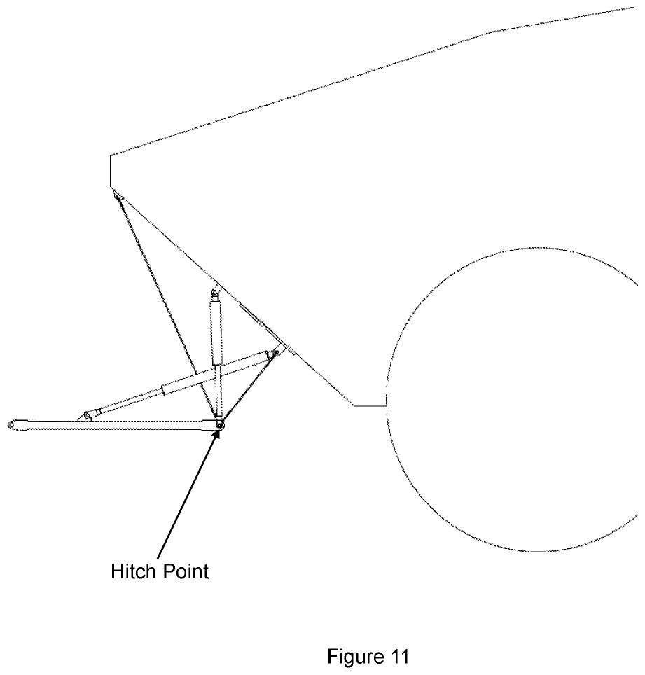

FIG. 11—the deployment structure in the fully deployed position.

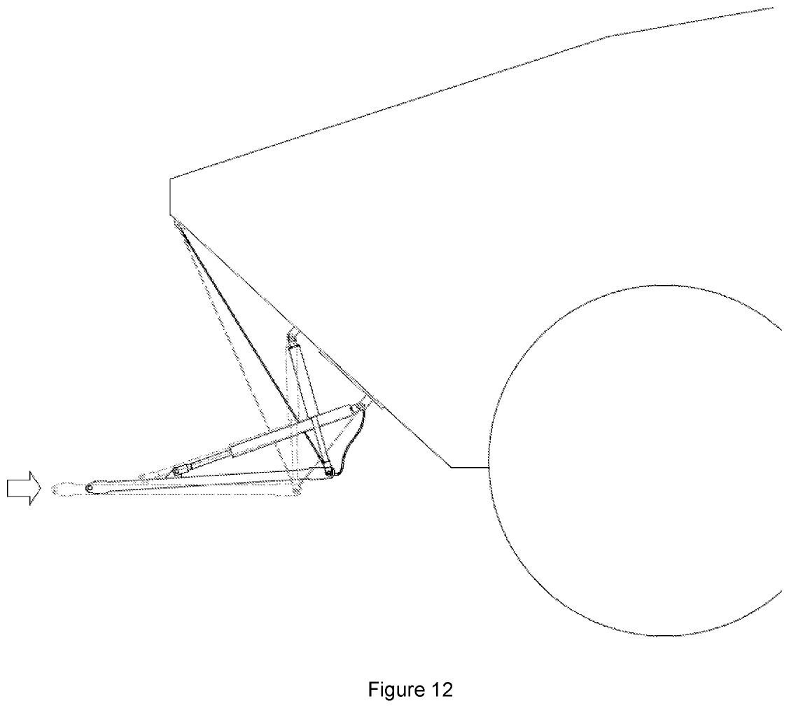

FIG. 12—the deployment structure as if an overload force has been applied to the front of the boom.

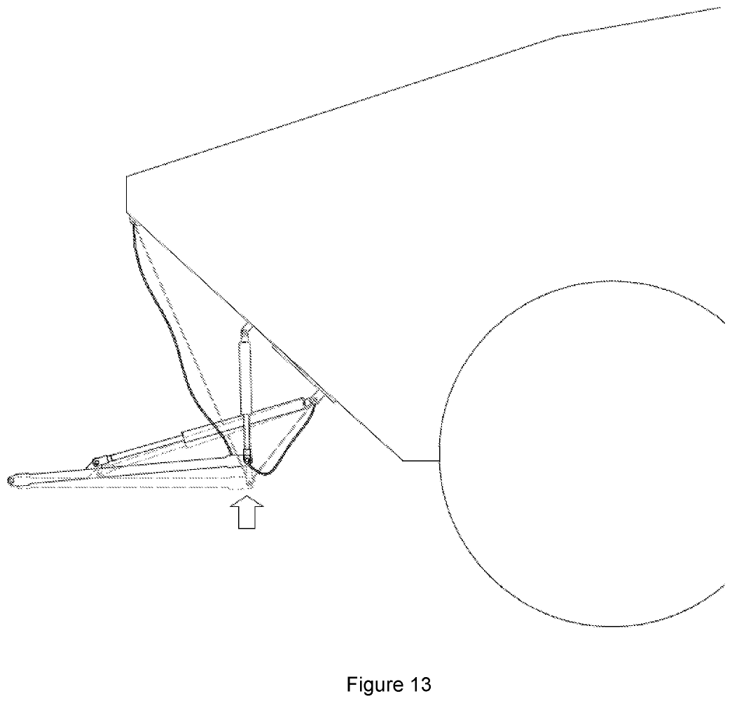

FIG. 13—the deployment structure as if the boom strikes an immovable object and the hitch point deflects upwards, or in any other direction.

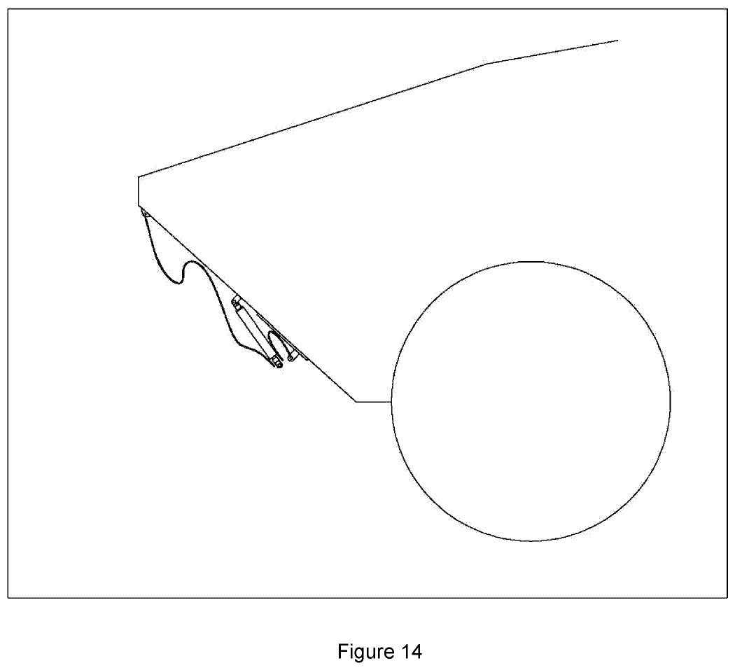

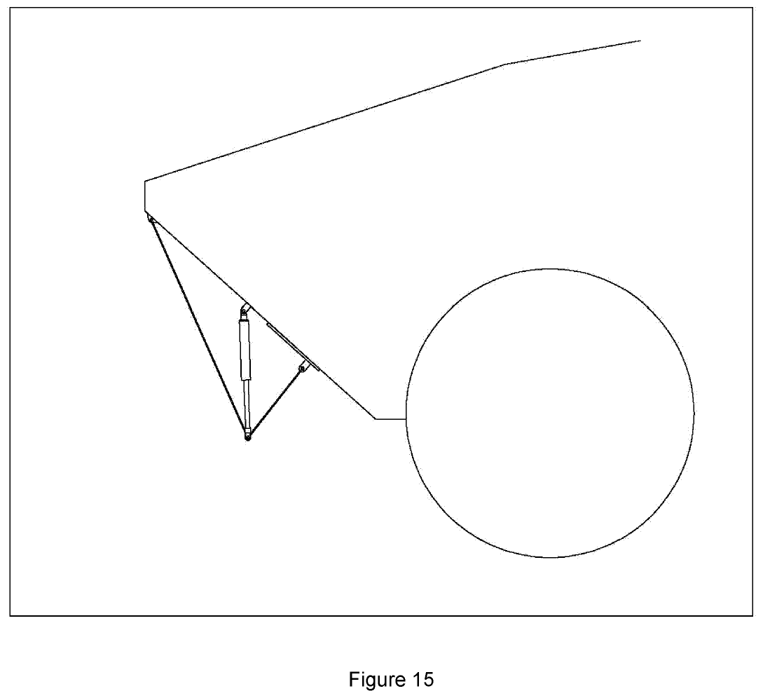

FIG. 14 and FIG. 15—stowed and deployed positions of a hitch formed according to a further embodiment.

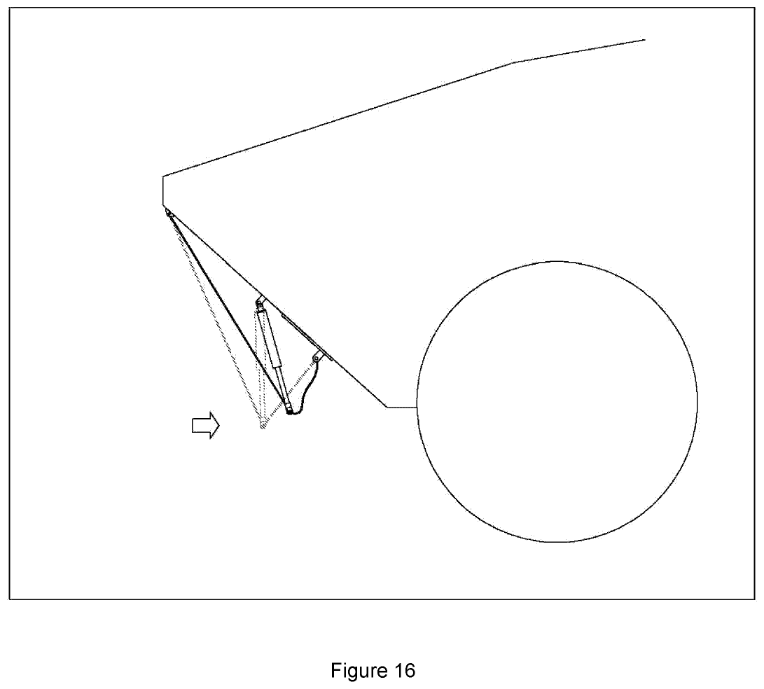

FIG. 16—illustrate that if the structure of FIG. 15 is overloaded from excessive draught force it can deflect rearwards and can be made to recover the original position.

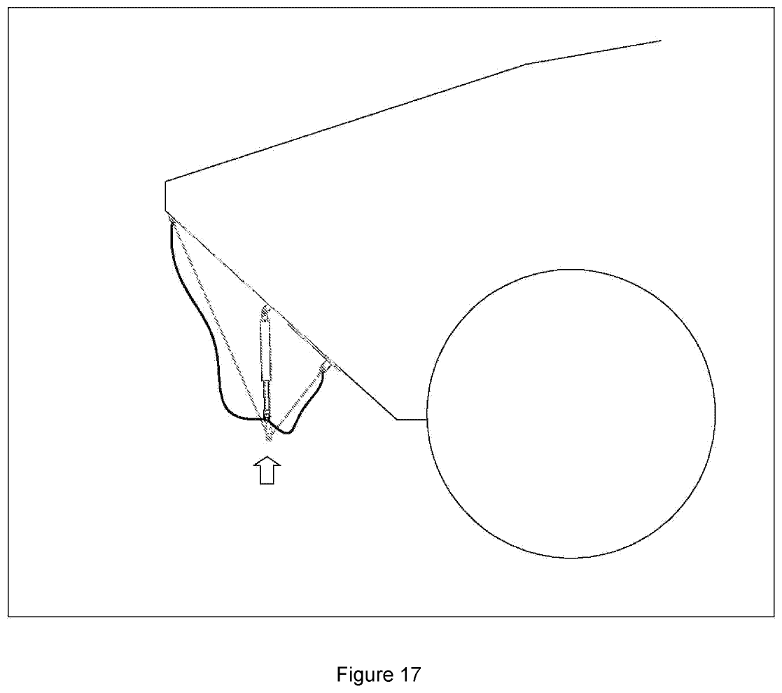

FIG. 17—illustrates that if the structure of FIG. 15 strikes an immovable object, such as debris or extreme undulations in the ground surface, the structure is able to deflect upwards, or in any other direction and can be made to recover the original position.

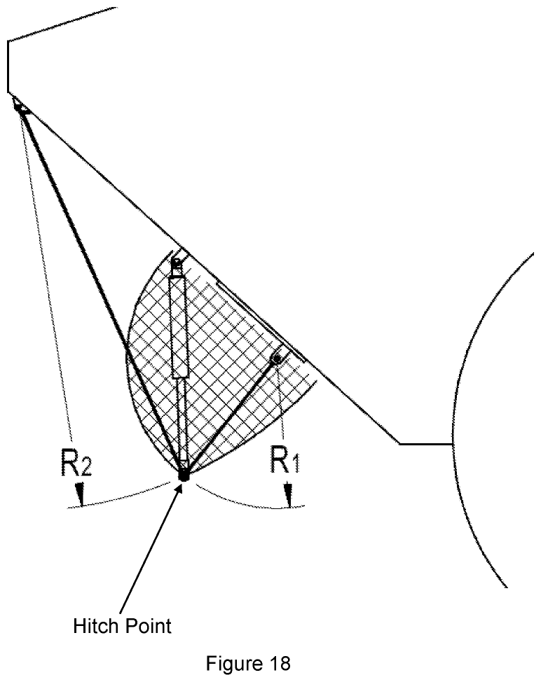

FIG. 18—a 2D system comprising one actuator and two ropes.

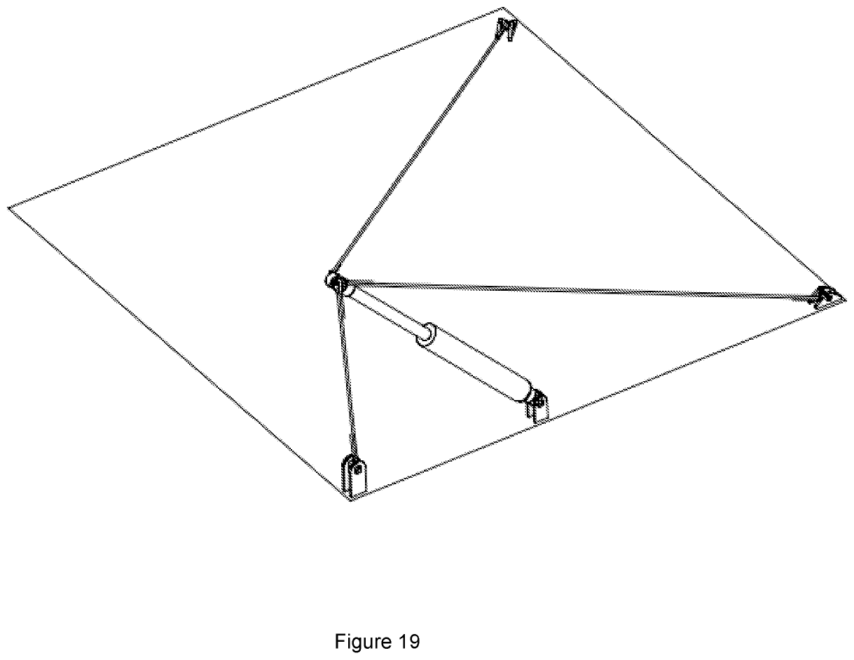

FIGS. 19 to 22—a 3D system comprising three tautable ropes.

The example embodiments are described in sufficient detail to enable those of ordinary skill in the art to embody and implement the systems and processes herein described. It is important to understand that embodiments can be provided in many alternative forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In the description, all orientational terms, such as upper, lower, radially and axially, are used in relation to the drawings and should not be interpreted as limiting on the invention.

FIG. 1: A simple “Real Hitch Point” where a boom (A) is directly attached to a vehicle (B) with a rigid connection (C), shown in the working position, with a tool (not shown) lowered to the ground. It is simple and lightweight but the angle of the boom directs the weight of the vehicle in to the tool and when subject to a large draught force the tool will be pressed in to the ground with greater force.

FIG. 2: The Real Hitch Point is also limited by the stowed position. The tool can be raised from the ground but the equipment cannot be returned to a compact stowed position in such a simple implementation.

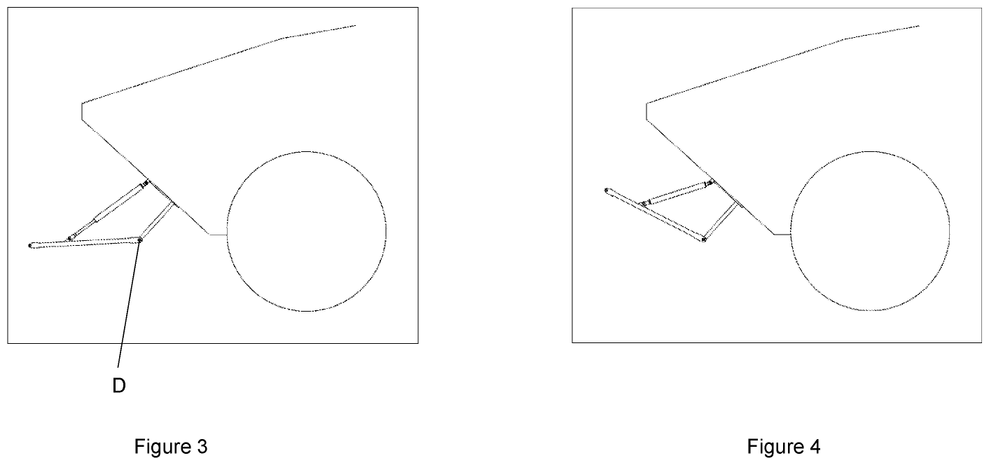

FIG. 3: A Real Hitch Point can be improved by moving the connection point (D) lower to the ground. This limits the undesirable force increase and ground pressure, when subjected to a large draught force. The undesirable consequence of the low connection point is a reduction in ground clearance.

FIG. 4: This simple implementation has a similar limitation on the compactness of the stowed position. The tool can be raised but compact stowage is not possible.

All of these hitch points may allow the tool to pivot freely and contour the ground, the tool may be rigidly attached to the boom, in which case the tool will rotate with the boom, or the tool may pivot on the end of the boom and be controlled by an additional actuator.

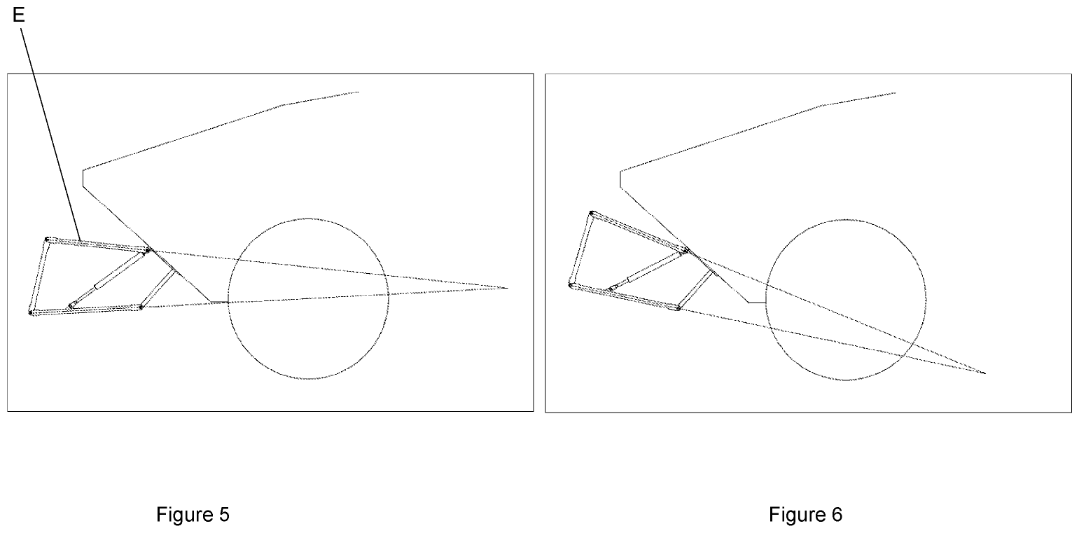

FIG. 5/6: A further development of a low hitch point could be the 3-point hitch or a “virtual hitch point” where an additional, upper boom (E) is added, which is also pivotably connected to the tool. This control the pitch angle of the tool but also directs the forces through a point (represented in the figure) by the meeting of the dashed lines. This allows the draught forces subjected to the tool and the vehicle to be carefully controlled. The location of the hitch point will move slightly through the working position of the tool.

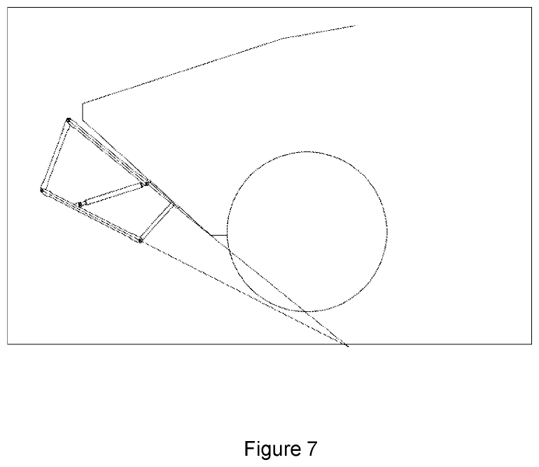

FIG. 7: The 3-point hitch is still limited in how much it can be compactly stowed.

FIGS. 8 to 11 illustrate a hitch mechanism (10) formed in accordance with the present invention and shown coupled to a host vehicle 2 in a stowed (FIG. 8), intermediate (FIG. 10) deployed (FIGS. 9 and 11) position.

The hitch mechanism is initially stowed up close to the host vehicle (FIG. 8). Actuators (3) and (4) are compressed. These may be pre-charged and stored energized or may be connected to an external power source. Ropes (5) and (6) and actuator (4) connect the rear of the boom (1) to the vehicle (2) in a forward and rearward position. The ropes are essentially slack in the stowed position but their excess length may be controlled by additional weak springs or weak restraints to ensure they pack neatly.

A facility to lock the mechanism, or parts of the mechanism, into the stowed position may or may not be required/provided.

When the system is released, actuator (4) is commanded to move and extends (FIG. 10); the mechanism starts to deploy (FIG. 10). This moves the rear end of the boom (1) to a low, stable position about which the boom can pivot during operations; a real hitch point (RHP) has been formed.

Latterly, the second actuator (3) is commanded to move. This lowers the boom (1) and any attached ground-clearing tools or other equipment to the ground (FIG. 11). In the case of ground clearing tools it can applied a near-constant “pushdown” force, while able to contour the ground.

In some ways this arrangement can be thought of as a pin-jointed triangle. The ropes are only capable of transmitting tension and the actuator (4) serves as a strut between them, connecting common ends of the ropes at an apex which then creates the hitch point in space.

The use of ropes, wires or the like and actuators allows a simple system using a real hitch point in the ideal location to be generated, where the forces subjected to equipment and vehicle and minimized.

The use of ropes, wires or the like and actuators allows the rigid structure to be collapsed for compact stowage.

There may be multiple sets of this 2-dimensional mechanism across the width of the vehicle.

If the structure is overloaded from excessive draught force, the structure can deflect rearwards (see FIG. 12) and can be made to recover the original position.

If the structure strikes an immovable object, such as debris or extreme undulations in the ground surface, the structure is able to deflect upwards, or in any other direction (see FIG. 13) and can be made to recover the original position.

FIG. 14 and FIG. 15 show stowed and deployed positions of a hitch formed according to a further embodiment. The hitch point actuator and ropes are shown. FIG. 15 illustrates the generation of the hitch point using the actuator and the ropes.

The hitch point is a point in the generally triangular linkage. It could be considered as a real hitch point, but it is movable in the event of an overload—see below.

If the structure is overloaded from excessive draught force, the structure can deflect rearwards (see FIG. 16) and can be made to recover the original position.

If the structure strikes an immovable object, such as debris or extreme undulations in the ground surface, the structure is able to deflect upwards, or in any other direction (see FIG. 17) and can be made to recover the original position.

A simple 2D system is illustrated in FIG. 18 comprising one actuator and two ropes, assumed to act in a plane. The two rope radii (R1 and R2) are marked. The hitch point when fully deployed is at the vertex. If one rope is slack then the hitch point will move along one edge. If both ropes are slack the hitch location (e.g., hitch point) will be located inside the hatched area. Note the similarities between FIG. 18 and FIG. 15.

Referring now to FIGS. 19 to 22 a generic 3D embodiment is shown, including three taut cables from three corners of the rectangular plate (the vehicle front) individually create three spherical surfaces and the hitch point is able to move within the common volume of these three spheres, i.e., the hitch moves over the surfaces show when two of the cables are slack and one taut. It moves along the lines where two surfaces interest when one cable is slack. And the hitch point is at the point where the three surfaces meet when all the cables are taut. When all three cables are slack, the hitch location is somewhere inside this surface envelope.

FIG. 19 illustrates an assembly of three ropes and an actuator to tension them.

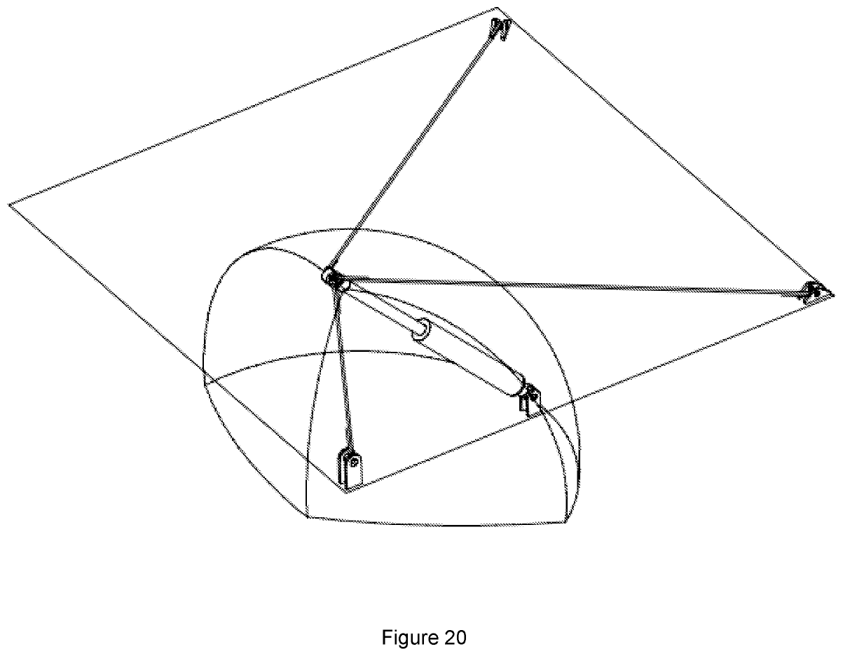

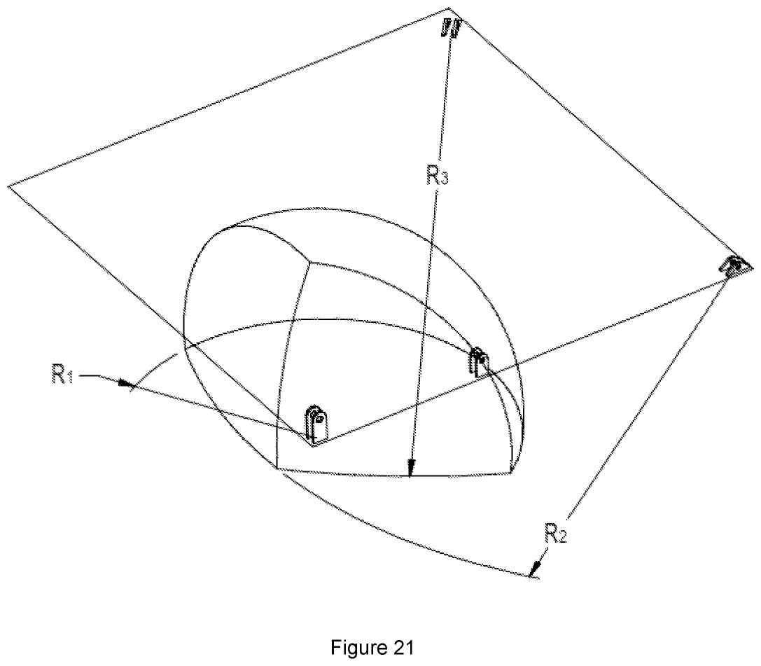

FIG. 20 illustrates a 3D shape envelope showing possible positions of hitch point, should the actuator be overloaded and rope/s become slack. FIG. 21 further draws attention to the radius of each face, which is generated by a rope.

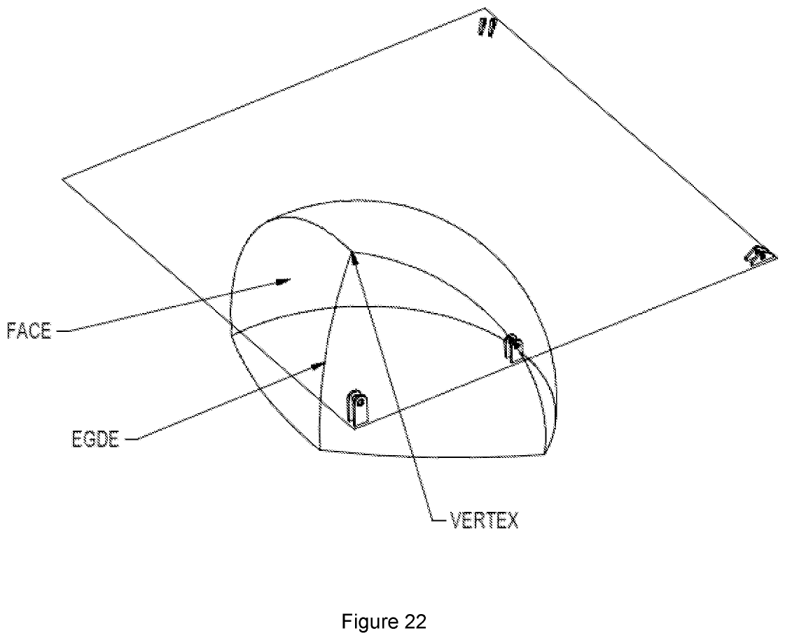

In FIG. 22 the key points of the shape are labelled, explaining the possible positions of hitch location:
a. If the actuator is fully extended then all ropes are taut and the hitch location is located at the “vertex”
b. If the actuator is overloaded and is no longer fully extended the hitch point location is undefined:
i. If one rope is slack then the hitch point is located along one “edge” (n.b. there are three edges on the diagram)
ii. If two ropes are slack then the hitch point is located one “face” (n.b. there are three faces on the diagram)
iii. If all ropes are slack then the hitch point is located inside the volume.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A vehicle-to-implement hitch comprising a force transfer hitch connector adapted to provide a hitch point to which an implement can be connected, wherein the hitch is movable between a stowed configuration and a deployed configuration and is deployable from a vehicle in use, wherein the connector is couplable to the vehicle by two or more flexible tensioning members which are relaxed in the stowed configuration and taut in the deployed position and which create a pseudo-rigid structure in the deployed configuration comprising a hitch location such that the hitch point is movable, whereby the pseudo-rigid structure provides for a controlled over-load reaction from which the structure can recover without damage.

2.-5. (canceled)

6. The hitch according to claim 1, in which the connector is a boom.

7. The hitch according to claim 1, in which the hitch location is real.

8. The hitch a according to claim 1, in which the hitch location is a pivot point that is part of a linkage that forms a virtual hitch point.

9. The hitch according to claim 1, in which the connector is in advance of the hitch location.

10. The hitch according to claim 1, in which the connector is part of the hitch point.

11. The hitch according to claim 1, further comprising one or more actuators for moving the hitch from the stowed to the deployed configuration.

12. The hitch according to claim 11, in which the or each actuator is pre-charged and stored energised and/or in which the or each actuator is connected or connectable to an external power source.

13.-14. (canceled)

15. The hitch according to claim 1, comprising a plurality of actuators in which actuators deploy in sequence or actuators deploy simultaneously.

16.-17. (canceled)

18. The hitch according to claim 1, in which in the deployed position tensioning members assume a triangular configuration with the hitch point formed at an apex thereof.

19. The hitch according to claim 1, in which at least one of the two or more tensioning members is a cable, rope, strap, cord, or chain.

20. The hitch according to claim 19, in which the tensioning member is a wire rope.

21. The hitch according to claim 19, in which excess length of the cable, rope, strap, cord, or chain is controlled to ensure they pack neatly.

22. The hitch according to claim 1, further comprising means for locking the mechanism, or parts of the mechanism, into the stowed position.

23. The hitch according to claim 1, consisting of two or three tautable tensioning members.

24. The hitch according to claim 1, formed as a 2D mechanism.

25. The hitch according to claim 1, formed as a 3D mechanism.

26. A hitch mechanism comprising a deployable structure which is deployed from a compact, stowed configuration using actuators and flexible members which becomes rigid when tensioned and create a hitch location in which the resulting structure is able to collapse if hits an obstacle and then re-form after passing the obstacle.

27.-29. (canceled)

30. A mine clearance system comprising a vehicle-to-implement hitch according to claim 1 and a surface clearance implement connected to the vehicle via the hitch.
